(19) United States
(12) Patent Application Publication
(10) Pub. No.: US 2014/0369019 A1
(43) Pub. Date: Dec. 18, 2014

(54) Power tool operating device

(71) Applicant: William J. Sabia, Yorba Linda, CA (US)

(72) Inventor: William J. Sabia, Yorba Linda, CA (US)

(21) Appl. No.: 14/301,821

(22) Filed: Jun. 11, 2014

Related U.S. Application Data
(60) Provisional application No. 61/834,708, filed on Jun. 13, 2013.

(51) Int. Cl. B24B 23/00; H02G 11/00

(52) U.S. Cl. CPC B24B 23/005; H02G 11/006
USPC 361/828

(57) ABSTRACT

A power tool operating device includes a tool shaft, further including a main handle shaft and a tool mounting shaft; a power tool mounting head, further including a bracket, including left and right bracket forks; a control handle; a comfort grip; a wiring harness, including a female electrical plug, a momentary electrical switch, and a male electrical plug, such that a power tool can be attached to the power tool mounting head, whereby a user can operate the power tool at floor level while the user remains standing. The length of the tool shaft can be adjusted by a telescoping function, allowing the tool mounting shaft to be locked in place with a scoping clamp. The angle between the tool shaft and the power tool mounting head can be adjusted and locked in place. The tool shaft can further include an adjustable and lockable joint, permitting variable angle adjustment.

### CROSS-REFERENCE TO RELATED APPLICATIONS

This application claims the benefit of U.S. Provisional Application No. 61/834,708, filed Jun. 13, 2013.

### FIELD OF THE INVENTION

The present invention relates generally to the field of power tool operating devices, and more particularly to novel devices for improving the operation of hand held power tools.

### BACKGROUND OF THE INVENTION

Hand held power rotary tools such as electric polishers and angle grinders, generally called power tools, are limited in their useful application.

Power tools are designed to be used close to the user's body, such that with material and surfaces being worked on have to be in close proximity, within arm's reach relative to the user's body.

Additionally, manipulation of the power tool is limited by the physical size of the user, his/her scope of reach, and tolerance for unusual body positioning.

Without an added extension handle device, the power tool user may be forced to:
a. Work on his/her knees for floor level operations, such as polishing stone floors or scrubbing carpet;
b. Bend severely at the waist or otherwise lean over strenuously to polish or grind material or surfaces that are elevated off the ground, or are otherwise hard to reach. Examples include (1) the user polishing a large vehicle where he/she must lean over to reach the center of the vehicle roof or hood or (2) the user polishing a large countertop requiring him/her to lean over to reach certain areas;
c. Hold the polisher or angle grinder above his/her shoulder height, in an ergonomically strenuous position, to work on taller walls, monuments, or other structures, where the surface runs perpendicular to the floor or ground and is elevated above shoulder level; or
d. Forego working on materials, which are in hard to access areas. For example, scrubbing carpets under beds, which are at floor level, but having limited vertical clearance.

Presently there are no general solutions for expanding the useful application of such power tools. Existing tools or related extension devices only address limited parts of the problems described above.

As such, considering the foregoing, it may be appreciated that there continues to be a need for novel and improved devices and methods for extending the operation of handheld power tools.

### SUMMARY OF THE INVENTION

The foregoing needs are met, to a great extent, by the present invention, wherein in aspects of this invention, enhancements are provided to the existing models for usage of hand-held power tools.

In various aspects, the present invention seeks to provide a solution to the above described problems associated with operation of hand-held power tools, by providing a power tool operating device having an electric switch that allows the user to operate the power tool, such that the power tool is positioned at floor or ground level, while the user remains standing in an upright position.

In an aspect, a power tool operating device can include a tool shaft and a power tool mounting head, such that the power tool mounting head is attached to a lower end of the tool shaft, and a power tool can be attached to the power tool mounting head.

In related aspects, the main body of the power tool operating device can be of sufficient length so that the face of the power tool may be applied to floor or ground level surfaces, while the device handles are operated by the user at approximately waist level.

In a further related aspect, the overall length of the power tool operating device can be adjustable, providing for comfortable use by users of varying body heights and types.

In a related aspect, a control handle can be mounted on the tool shaft of the power tool operating device, along with a comfort grip at the upper end of the tool shaft, thereby allowing for two handed manipulation and stabilization of the power tool operating device during use. The control arm can be removed and reattached in varying orientation to the user's preference.

In a related aspect, the tool shaft of the power tool operating device can be angled in key positions to allow for comfortable operation, while applying a polisher or sander head to floor/ground level material.

In related aspects, multiple versions of the power tool mounting head can be provided to allow for single or multiple power tools to be operated simultaneously.

In related aspects, the electrical harness includes an on/off momentary electrical switch, housed in a main handle of the device, which is easily manipulated by the user's thumb. When the user applies pressure to the momentary switch, electricity is supplied to the polisher and it turns “on”. When pressure is removed from the momentary switch, electricity is interrupted and the polisher turns “off”. The intent of the momentary on/(off) switch is to provide for only positive, intentional, operation of the polisher, so that if the device is dropped or intentionally released, the power tool automatically turns off.

Thus, in the various related aspects, the power tool operating device can be used on a variety of different surfaces and objects, including floors, counter tops, vehicles, walls, ceilings, and other hard to reach areas such as spaces above cabinets, etc. Furthermore, the power tool operating device can be quickly reconfigured to switch from one use to another, in contrast to existing tools and tool extensions, which are generally limited and specialized for particular usage scenarios.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a perspective view of a power tool operating device with an attached power tool, according to an embodiment of the invention.

FIG. 2 illustrates a perspective view of a power tool operating device in a retracted state, according to an embodiment of the invention.

FIG. 3 illustrates a perspective view of a power tool operating device in an extended state, according to an embodiment of the invention.

FIG. 4 illustrates a perspective view of a power tool operating device with an attached power tool, according to an embodiment of the invention.

FIG. 5 illustrates a perspective view of a power tool mounting head, according to an embodiment of the invention.

FIG. 6 illustrates a perspective view of the lower end of a tool shaft of the power tool operating device, according to an embodiment of the invention.

FIG. 7 illustrates a perspective view of a power tool operating device with an adjustable and lockable ball joint, according to an embodiment of the invention.

FIG. 8 illustrates a perspective view of a power tool mounting head with two brackets mounted side-by-side, according to an embodiment of the invention.

FIG. 9 illustrates a perspective view of a power tool operating device, wherein the tool shaft includes a flexible and adjustable tube segment, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

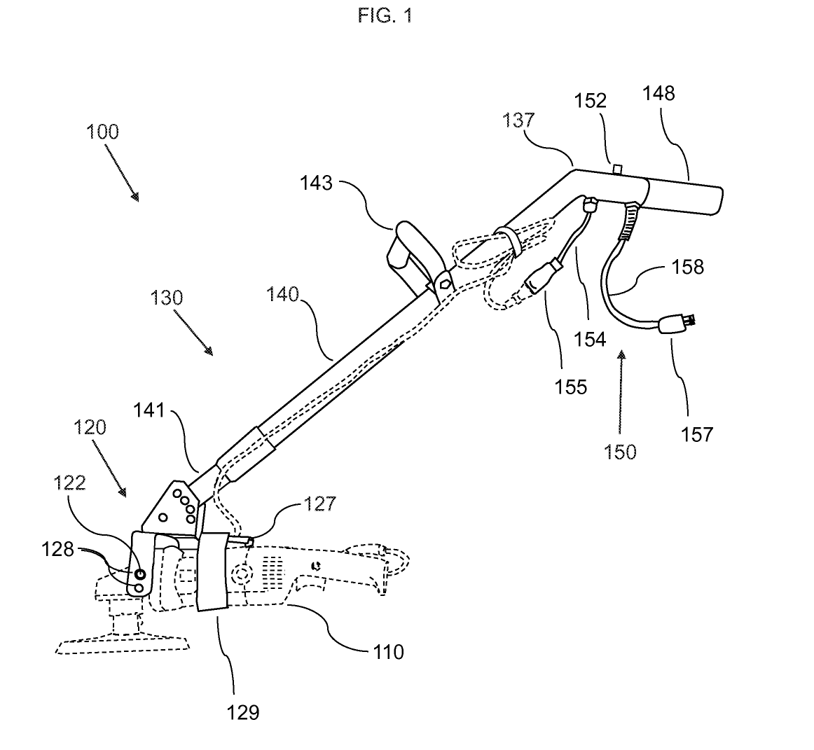

In the following, we describe the structure of an embodiment of a power tool operating device 100 with reference to FIG. 1, in such manner that like reference numerals refer to like components throughout; a convention that we shall employ for the remainder of this specification.

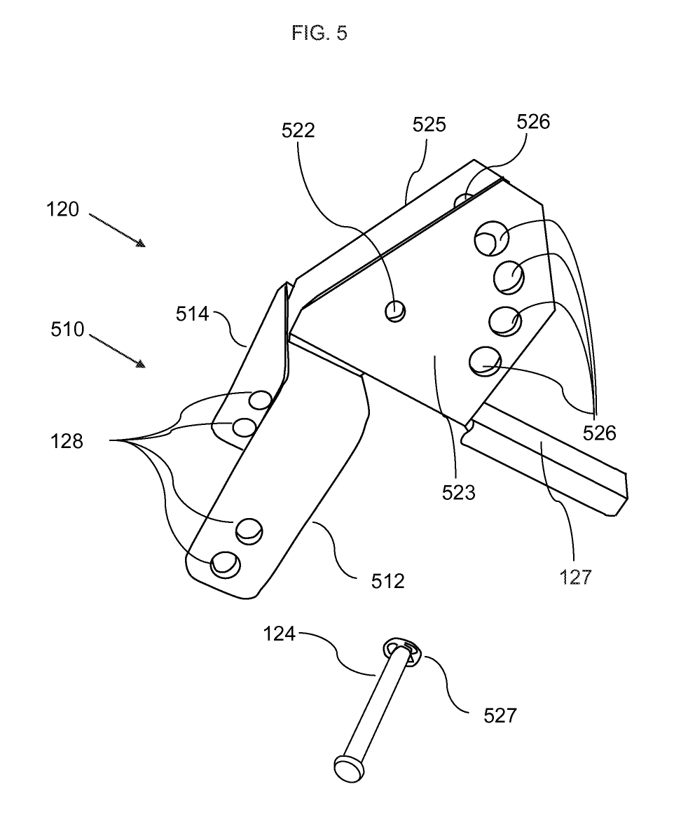

In an embodiment, as shown in FIG. 1, a power tool operating device 100 can comprise:
a. A tool shaft 130, which can further comprise
   i. a main handle shaft 140; and
   ii. a tool mounting shaft 141;
b. a power tool mounting head 120, further including a bracket 510, which includes bracket forks 512 514, as illustrated on FIG. 5, such that the power tool mounting head 120 is attached to a lower end of the tool shaft 130, which in some embodiment can be the lower end of the tool mounting shaft 141;
c. a control handle 143; mounted to a center part of the tool shaft 130, which in some embodiments can be a center part of the main handle shaft 140;
d. a comfort grip 148, mounted on the upper end of the tool shaft 130, which in some embodiments can be the upper end of the main handle shaft 140;
e. a wiring harness 150, that includes:
   i. A female electrical plug 155; which is connected to
   ii. A female electrical supply wire 154; which is connected to
   iii. a button actuated, in-line on/off momentary electrical switch 152; which is connected to
   iv. A male electrical supply wire 158; which is connected to
   v. A male electrical plug 157;
wherein a power tool 110 can be attached to the power tool mounting head 120, by placing the power tool 110 head between the mounting head bracket forks, such that threaded mounting holes on the power tool align with the power tool mounting holes 128 on the power tool mounting head 120 and attach to the power tool mounting head 120 with power tool mounting bolts 122.

In a related embodiment, the rear of the power tool can be further stabilized by securing it to the power tool mounting head 120 with a power tool fastener 129, such as a hose clamp or hook and loop strap, which wraps tightly around the power tool and the power tool mounting head 120. The power tool fastener 129 can be fastened to the power tool mounting head 120, by wrapping the power tool fastener 129 around a power tool fastening bar 127, which is connected to and protrudes to the rear of the power tool mounting head 120.

In a related embodiment, the upper part of the tool shaft 130 can be curved or bent, for example between the control handle 143 and the upper end of the tool shaft 130, to ensure a comfortable grip position for holding on to the comfort grip 148. In an embodiment, FIG. 1 shows an example position for a downward bend 137 of the tool shaft.

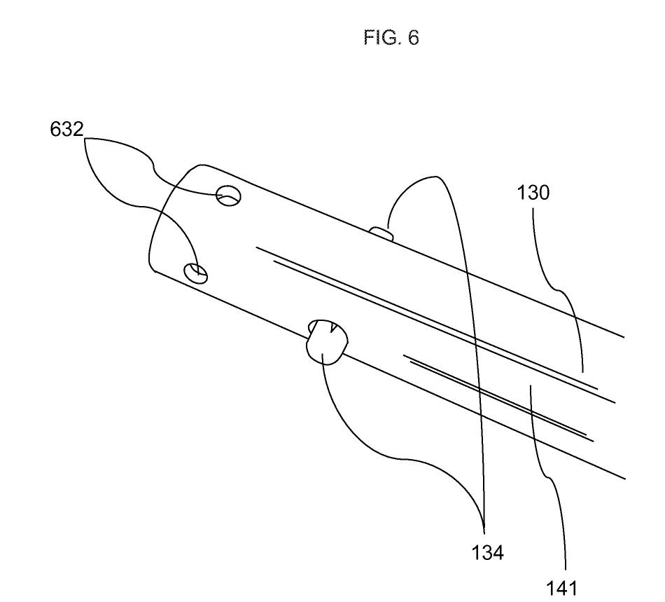

In a related embodiment:
a. the power tool mounting head 120 can, as shown in FIG. 5, further include upper flanges 523 525, including a right upper flange 523 and a left upper flange 525, such that the upper flanges 523 525 each include a head mounting hole 522, and a set of angle adjustment anchor holes 526 oriented in a semi-circle to the rear of the head mounting hole 522, a separation distance from the head mounting hole 522;
b. the tool shaft 130, which can also be the tool mounting shaft 141, as shown in FIG. 6, can further include:
   i. shaft mounting holes 632, on opposites sides with a connecting cavity going through the tool shaft 130, such that the shaft mounting holes 632 are located in the lower end of the tool shaft 130; and
   ii. detent snap pins 134, on opposites sides of the tool shaft 130, at the same level as the shaft mounting holes 632, such that the detent snap pins 134 are located inside and protruding from the lower end of the tool shaft 130, the separation distance further up the tool shaft from the shaft mounting holes 632;
such that the power tool mounting head 120 can be attached to the tool shaft 130 by inserting the lower end of the tools shaft 130 in between the upper flanges 523 525 of the power tool mounting head 120, such that shaft mounting holes 632, align with the head mounting holes 522 on the power tool mounting head 120, and such that the power tool is at the desired orientation relative to the surface being worked on. The head mounting pin 124 is then inserted through the head mounting holes 522 and shaft mounting holes 632 and secured by applying a nut or clip 527.

In related embodiments, the separation distance from the from the head mounting holes 522 to the corresponding angle adjustment anchor holes 526 can be in a range from 1″ to 5″. This can vary according to the size of the power tool operating device 100, and in some embodiments can be outside this range.

In a further related embodiment, the angle of the attachment of the tool shaft 130 with the power tool mounting head 120, can be adjusted by locking the tool shaft 130 in a position, based on selecting a corresponding set of angle adjustment anchor holes 526, located in an upper part of the power tool mounting head 120, such that the detent snap pins 134 of the tool shaft 130 can lock in position inside the angle adjustment anchor holes 526.

Related to the foregoing, FIG. 1 shows a configuration of an embodiment, wherein the power tool shaft 130 is connected to the power tool mounting head 120, such that the angle between the power tool and the power tool shaft is approximately 45 degrees, which for example can be suitable for polishing or sanding a floor.

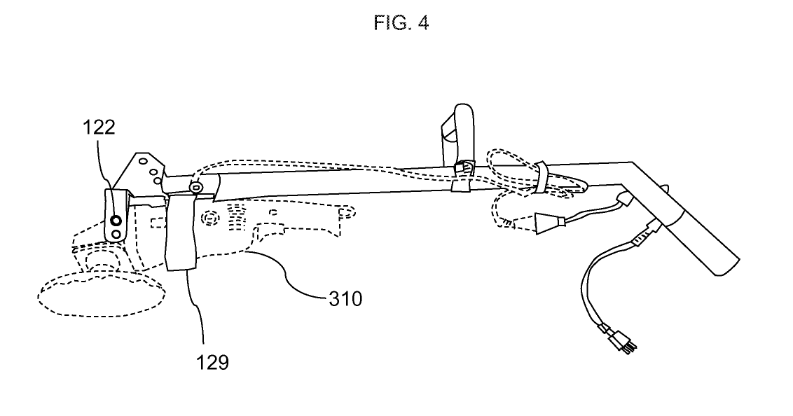

Alternatively, FIG. 4 shows a configuration of an embodiment, wherein the power tool shaft 130 is connected to the power tool mounting head 120, such that the angle between the power tool and the power tool shaft is approximately zero degrees, which for example can be suitable for polishing or sanding a table top, or polishing a large vehicle.

In an alternative embodiment, an adjustable and lockable joint can be used to allow for variable angle adjustment, instead of fixed angle options, to allow for enhanced customization depending on user preference.

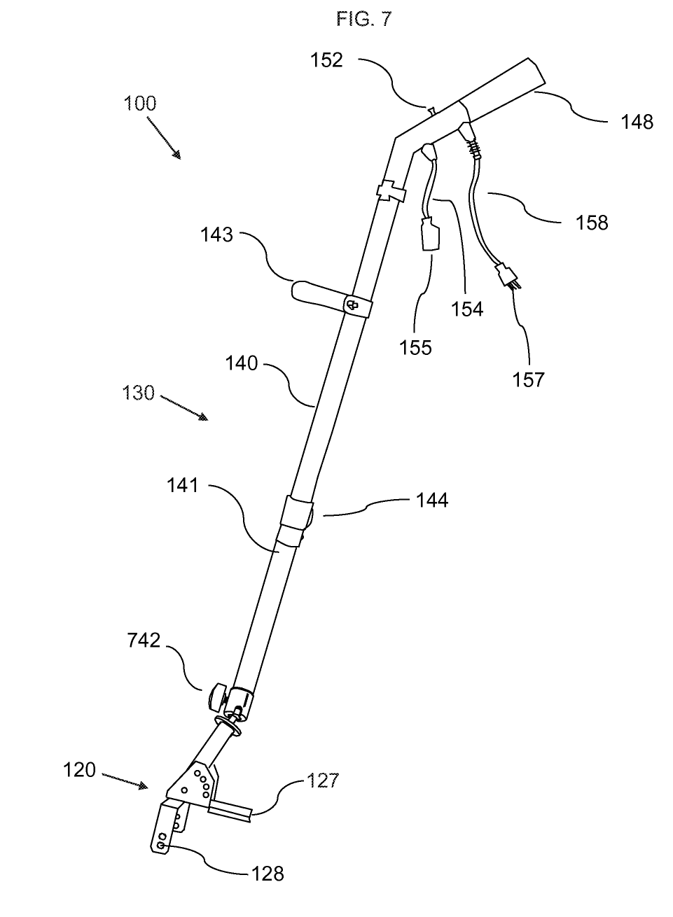

In a further related alternative embodiment, FIG. 7 shows an adjustable and lockable ball joint 742 located in the lower part of the tool shaft 130, which in the figure also corresponds to the tool mounting shaft 141, such that the adjustable and lockable ball joint 742 is located in close proximity to the rear-end of the power tool mounting head 120 when the tool shaft 130 is mounted to the power tool mounting head 120, such that close proximity typically corresponds to a range of 0.5″-4″ from the rear-end of the power tool mounting head 120 when the tool shaft 130 is mounted to the power tool mounting head 120.

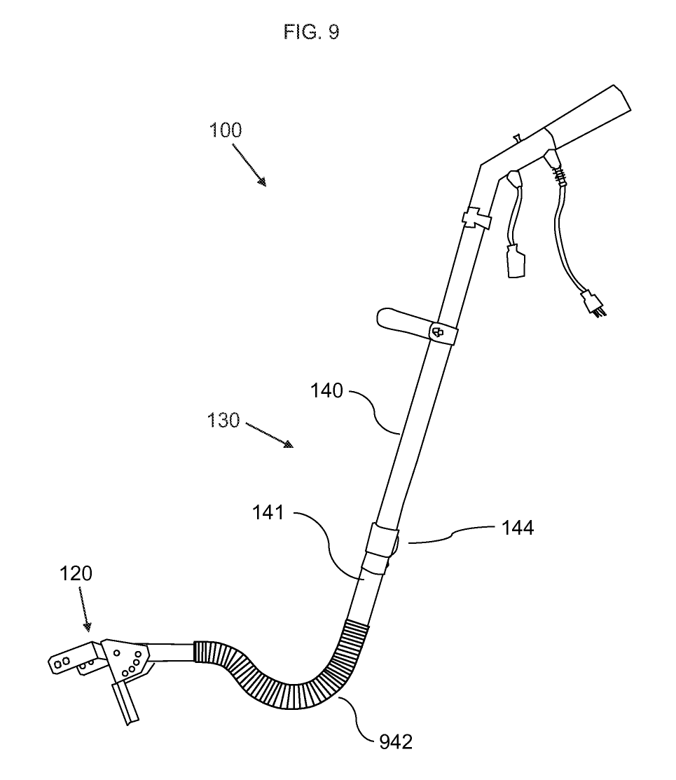

In another further related alternative embodiment, as illustrated in FIG. 9, a part of or all of the tool shaft 130 can be configured with a flexible and adjustable tube segment 942, commonly called a gooseneck arm or gooseneck shaft, which allows for adjusting the shape and orientation of the flexible and adjustable tube segment 942. Gooseneck arms are well known for use with table lamps and reading lamps, wherein the flexible gooseneck arm can be used to position a light in a comfortable position for reading or other work.

In related embodiments, the flexible and adjustable tube segment 942 has to have a sufficient stiffness, such that it is not too stiff, thereby allowing a user to adjust the shape and orientation of the flexible and adjustable tube segment 942, while being stiff and sturdy enough to hold its shape and orientation during use of the power tool operating device 100 with a power tool 110 installed therein.

FIG. 9 illustrates an embodiment wherein the flexible and adjustable tube segment 942 is a segment of the tool mounting shaft 141. In other embodiments, most or all of the tool shaft below the control handle 143 can be configured with a flexible and adjustable tube segment 942, and in yet other embodiments the entire tool shaft 130 can be a flexible and adjustable tube segment 942.

In a related embodiment, the power tool's male electric plug can be inserted into the female electric plug 155 of the wiring harness 150. The male electric plug 157 of the wiring harness 150 can be attached to an extension cord, which in turn, can be attached to an electrical power supply, such as a common household electrical outlet.

In related alternative embodiments, power can be supplied by a battery, which can either be attached to the power tool operating device 100 or carried separately along with the power tool operating device 100. The battery can be rechargeable.

In related embodiments, the in-line momentary on/off electrical switch 152 can instead be implemented as a trigger or paddle actuator.

In a related embodiment, the overall length of the tool can be adjusted, by adjusting the length of the tool shaft 130. The tool shaft can for example be telescoping, comprising of two or more telescoping shaft elements.

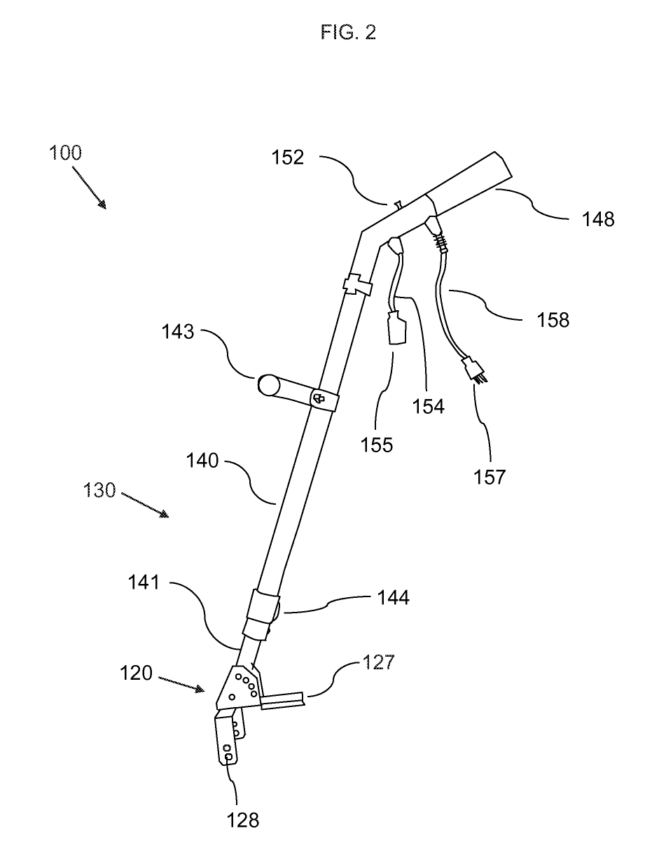

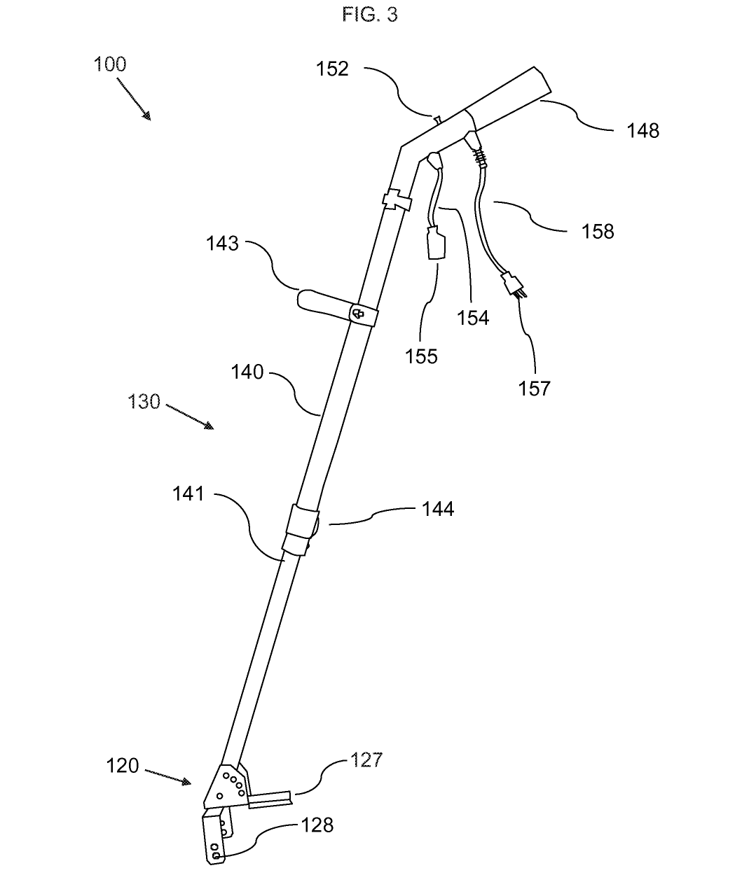

In a further related embodiment, illustrated in FIG. 3, the tool shaft 130, can be comprised of:
a. a main handle shaft 140, further comprising a scoping clamp 144, such that the main handle shaft 140 corresponds to the upper part of the tool shaft 130; and
b. a tool mounting shaft 141, such that the tool mounting shaft 141 corresponds to the lower part of the tool shaft 130;
such that the tool shaft 130 is configured to be telescoping, with the tool mounting shaft 130 partially inside the main handle shaft 140, such that the tool mounting shaft 130 can be locked in position by engaging the scoping clamp 144.
FIG. 3 shows the power tool operating device 100 in a fully extended state, as compared to FIGS. 1, 2, and 4, which show the power tool operating device 100 in a retracted state.

In an alternative embodiment, the tool shaft 130 can comprise steel bars in a fork and bolt configuration to achieve the length adjustability feature, such that the tool mounting shaft 141 can slide inside the main handle shaft 140, which is configured as a fork and secured by bolts and nuts.

In various embodiments, many operations performed by the power tool operating device 100 can be greatly enhanced by taking advantage of the attached power tool's 110 rotation, which can help propel the tool across the material/surface. For example, if a user is polishing a stone floor and wishes to manipulate the tool to his right or left, he may achieve this by simply applying upward or downward pressure on the device handle. This pressure causes the rotating face of the tool to grab the material surface, which in turn propels the tool either right or left.

In further related embodiments, to allow for this propulsion feature, characteristics of the tool shaft 130 can include:
1. The tool shaft 130 can be fixable in a given orientation to the power tool face. For example, the user may be standing grasping the device at a 45-degree angle to the floor while the face of the power tool sits flat on the floor. For propulsion to occur it is essential that pressure applied to the handle be transmitted to the face of the tool. Therefore, the handle must not pivot or move independently from the power tool, such that no pressure is transmitted to the face of the tool.
2. No part of the handle, such as supporting wheels, or any other stabilizing element, etc., must come into contact with the work surface in such a way that it prevents downward or upward pressure from being fully transmitted to the face of the tool and thus preventing or limiting the propulsion feature. For example, if the handle were to also incorporate supportive wheels, either in front of or behind the power tool 110, that rested on the floor surface while the face of the tool is also on the floor surface, upward and downward pressure applied to the handle would be distorted interfering with the propulsion effect.

Common hand held power tools in the form of electric polishers or angle grinders can be used primarily to buff, polish, grind, scarify or cut surfaces and materials such as automobile finishes, or miscellaneous metal working projects, with the object surface positioned at approximately waist height to the user. If a user wishes to use the power tool for applications such as, scrubbing carpets, sanding wood floors or decking, scarifying cement floors or polishing stone floors, the user must assume a kneeling position or otherwise position his body at or near floor level to accomplish the task. The area the user is able to work on is limited to the user's body type and length of his appendages, requiring the user to re-position frequently to work on new areas.

In various embodiments of the power tool operating device 100, such a power tool can be operated from a more comfortable, standing position while working on floor or ground level materials such as carpet, wood, cement or stone flooring. The area the user is able to work on is greatly expanded requiring the user to re-position less frequently with less substantial body movement due to the added reach provided by the power tool operating device 100.

In related embodiments, while using the power tool operating device 100, the user grips the comfort grip 148 with a first hand and the control handle 143 with a second hand.

In related embodiments, the power tool can be powered on by the user applying pressure to the momentary on/(off) switch 152, located on the upper part of the tool shaft 130, with his thumb. The power tool is powered off by the user removing his thumb from the switch.

In further related embodiments, the momentary on/off switch can be positioned in other locations on the device, such as in proximity to the control handle 143.

In related embodiments, the power tool mounting head 120 has at least one bracket 510 into which the power tool can be mounted.

In a further related embodiment, as illustrated in FIG. 5, the bracket 510 can further comprise two bracket forks, a left bracket fork 512, and a right bracket fork 514. The bracket forks 512 514 further comprise power tool mounting holes 128, such that the power tool 110 can be mounted in between the bracket forks 512 514 using power tool mounting bolts 122.

In further related embodiments, the power tool mounting head 120 can include two or more brackets, allowing for simultaneous operation of multiple power tools. The two or more brackets can for example be mounted side-by-side.

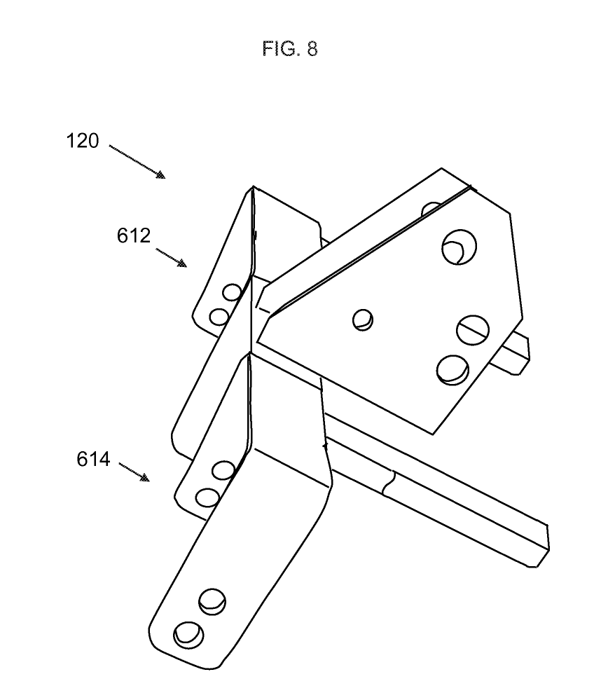

FIG. 8 illustrates an example embodiment, with two brackets 612 614, comprising a right bracket 614 and a left bracket 612, such that the two brackets 612 614 are mounted side-by-side.

In yet other further related embodiments, the power tool mounting head 120 can include a cradle into which the power tool 110 is rested and secured, rather than being suspended from the head of the tool by brackets.

In a related embodiment, the power tool mounting head 120 can be detachable and therefore interchangeable, allowing a user to alternate between single and multiple power tool operation. The detachable feature also allows the power tool mounting head 120 and power tool 110 to be removed, re-oriented, and reattached as desired for a variety of applications.

In a related embodiment, the control handle 143 can be adjustable and mountable at different heights and different orientation along the upper part of the tool shaft 130, allowing for comfortable use by both right and left-handed users of varying heights and arm lengths.

In yet another related embodiment, the control handle 143 can be permanently attached to the main handle, for example in order to simplify manufacturing and/or reduce manufacturing cost.

In various embodiments, the tool shaft 130 can be manufactured using rectangular columns, or circular or ellipsoid tubing.

In related embodiments, manufacturing materials for the tool shaft 130 and the power tool mounting head 120 can include:
a. Steel, stainless steel, aluminum, titanium, or other metal alloys;
b. Carbon fiber, glass fiber, or composite fibers;
c. Plastic, composite plastics, or other composite materials.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A power tool operating device, comprising:
a) a tool shaft;
b) a power tool mounting head; wherein the power tool mounting head is attached to a lower end of the tool shaft;
c) a wiring harness, further comprising an electrical switch, such that the electrical switch is connected between a female electric plug and a male electric plug;
wherein a power tool is attached to the power tool mounting head, and a power cord of the power tool is attached to the female electric plug of the wiring harness, and the male electric plug is attached to a power plug of an electrical power supply, such that the power tool is operated by a user placing the electrical switch in the on position.

2. The power tool operating device of claim 1, wherein the power tool mounting head further comprises at least one bracket, wherein the bracket comprises a left bracket fork and a right bracket fork, such that each bracket fork comprises power tool mounting holes, whereby the power tool is mounted between the left bracket fork and the right bracket fork with power tool mounting bolts that go through the power tool mounting holes and are tightened into the power tool.

3. The power tool operating device of claim 1, wherein the electrical switch is a momentary electric switch, whereby the power tool is activated once the user applies pressure to the electrical switch.

4. The power tool operating device of claim 1, further comprising a control handle.

5. The power tool operating device of claim 1, further comprising a comfort grip, such that the comfort grip is mounted on the upper end of the tool shaft.

6. The power tool operating device of claim 5, wherein the upper part of the tool shaft has a downward bend, whereby the downward bend ensures a comfortable grip position for holding on the comfort grip.

7. The power tool operating device of claim 5, wherein the electrical switch is positioned by the comfort grip, such that the electrical switch is user operable with a thumb of a hand holding the comfort grip.

8. The power tool operating device of claim 1, wherein the power tool mounting head further comprises a tool fastener, whereby the tool fastener further stabilizes the attachment of the power tool.

9. The power tool operating device of claim 8, wherein the tool fastener is a hook and loop strap, whereby the hook and loop strap is wrapped tightly around the power tool to stabilize the power tool in position.

10. The power tool operating device of claim 9, wherein the power tool mounting head further comprises a power tool fastening bar, which is connected to and protrudes to the rear of the power tool mounting head, such that the power tool fastener wraps tightly around the power tool fastening bar and the power tool, whereby the rear of the power tool is secured and stabilized.

11. The power tool operating device of claim 1, wherein:
a) the power tool mounting head further comprises upper flanges, such that the upper flanges each include a shaft mounting hole; and
b) the tool shaft further comprises head mounting holes, on opposites sides of the tool shaft with a connecting cavity going through the tool shaft, such that the head mounting holes are located by the lower end of the tool shaft;
such that the power tool mounting head is attached to the tool shaft by inserting the lower end of the tool shaft in between the upper flanges of the power tool mounting head, such that shaft mounting holes, align with the head mounting holes on the power tool mounting head, secured by a head mounting pin inserted through the head mounting holes and shaft mounting holes.

12. The power tool operating device of claim 10, wherein the power tool operating device is configured to allow adjustment of the angle of attachment between the tool shaft and the power tool mounting head.

13. The power tool operating device of claim 11, wherein:
a) the upper flanges of the power tool mounting head each further comprises a set of angle adjustment anchor holes oriented in a semi-circle to the rear of the shaft mounting hole, a separation distance from the shaft mounting hole; and
b) the tool shaft further comprises detent snap pins, on opposites sides of the tool shaft, at the same level as the head mounting holes, such that the detent snap pins are located by the lower end of the tool shaft, the separation distance further up the tool shaft from the head mounting holes;
whereby the angle of the attachment of the tool shaft with the power tool mounting head is adjusted by locking the tool shaft in a position, based on selecting a corresponding set of angle adjustment anchor holes, such that the detent snap pins of the tool shaft lock in position inside the angle adjustment anchor holes.

14. The power tool operating device of claim 13, wherein the separation distance is in a range from 1″ to 5″.

15. The power tool operating device of claim 1, wherein the tool shaft further comprises:
a) a main handle shaft, further comprising a scoping clamp, such that the main handle shaft corresponds to an upper part of the tool shaft, and wherein the main handle shaft is hollow; and
b) a tool mounting shaft, such that an upper part of the tool mounting shaft is inside the main handle shaft, further such that the tool mounting shaft corresponds to a lower part of the tool shaft;
such that the tool shaft is configured to be telescoping, with the tool mounting shaft partially inside the main handle shaft, such that the tool mounting shaft is locked in position with the scoping clamp.

16. The power tool operating device of claim 1, wherein the tool shaft further comprises at least one adjustable and lockable joint, such that the adjustable and lockable joint permits variable angle adjustment of segments of the tool shaft.

17. The power tool operating device of claim 16, wherein the adjustable and lockable joint is a an adjustable and lockable ball joint, such that the adjustable and lockable ball joint is located in the lower part of the tool shaft, such that the adjustable and lockable ball joint is located in close proximity to the rear-end of the power tool mounting head when the tool shaft is mounted to the power tool mounting head, such that the close proximity corresponds to a range of 0.5″-4″ from the rear-end of the power tool mounting head.

18. The power tool operating device of claim 1, wherein the tool shaft further comprises a flexible and adjustable tube segment.

19. The power tool operating device of claim 2, wherein the power tool mounting head comprises two brackets mounted side-by-side, whereby the power tool operating device allows for simultaneous operation of two power tools.

20. The power tool operating device of claim 1, wherein the tool shaft is manufactured from stainless steel tubes.
